(19) United States
(12) Patent Application Publication
(10) Pub. No.: US 2007/0122033 A1
(43) Pub. Date: May 31, 2007

(54) Methods and apparatus for binarising images

(76) Inventors: Qingmao Hu, Singapore (SG); Zujun Hou, Matrix (SG); Wieslaw Lucjan Nowinski, Singapore (SG)

Correspondence Address: Blakely Sokoloff Taylor & Zafman, 12400 Wilshire Boulevard, 7th Floor, Los Angeles, CA, 90025, US

(21) Appl. No.: 10/582,439

(22) PCT Filed: Dec. 9, 2004
(86) PCT No.: PCT/SG04/00403

§ 371 Date: Jun. 9, 2006

(30) Foreign Application Priority Data
Dec. 10, 2003 (SG) 200307531-4

(51) Int. Cl. G06K 9/34; G06K 9/38; G06K 9/00

(52) U.S. Cl. 382/171; 382/172; 382/128

(57) ABSTRACT

A method is proposed for binarising an image by deriving an intensity threshold and classifying pixels according to whether their intensity is below or above the threshold. In the derivation of the threshold, prior konwledge is used to define a region of interest (ROI) in the image. Furthermore, prior knowledge is used to select a range in the frequency distribution of the intensities of the pixels in the ROI, and that only data within this frequency range is used to derive the threshold. These techniques provide a highly effective mechanism for incorporating prior knowledge into the threshold selection which is critical whether the image is a medical image or not. In particular, a threshold can be found to binarise images which exhibits high robustness to imaging artefacts such a gray level inhomogeneity and noise.

### FIELD OF THE INVENTION

The present invention relates to methods for processing an image so as to classify pixels of the image based on an intensity threshold. In particular, the invention relates to such a method having an improved process for selection of the threshold. The invention is applicable to both medical and non-medical images.

### BACKGROUND OF INVENTION

Binarisation is a well-known technique for image segmentation—that is classifying pixels of the image into two classes. Binarisation performs this classification based on whether a given pixel of the image has an intensity (gray-level) above or below a threshold. Binarisation has been widely applied to a number of image processing and computer vision applications, as a preliminary segmentation step. It makes an implicit assumption that an object of interest in the image has different intensity values from other (background) portions of the image.

Many techniques exist for selection of the threshold. For example, in some such processes, the threshold can be selected in a process involving user interaction, while in other processes the threshold is selected entirely automatically. In some such processes the threshold is selected locally (i.e. such that the threshold varies from one pixel to another), while in other processes the threshold is the same over the whole image.

Most automatic threshold selection methods employ a histogram of the gray levels in the image. For example, Otsu [1] proposed a selection of the threshold to maximise the separability of the resultant classes in gray levels, which is performed by minimising the within-class variance. Li and Lee [2] selected the threshold by minimising the cross entropy between the image and its segmented version. Kittler and lllingworth [3] selected the threshold by minimising the Bayes errors under the assumption that the object and pixel gray level values are normally distributed. Kapur et al [4] provided a maximum entropy approach. Wong and Sahoo [5] maximised the entropy with constraints on the region homogeneity and object boundary. Saha and Udupa [6] proposed a technique which maximised class uncertainty and homogeneity of the regions. Cheng et al [7] used the concept of fuzzy c-partition and the maximum fuzzy entropy principle to select a threshold.

Cheung at al (U.S. Pat. No. 5,231,580A, 1993) disclosed an automatic method to characterise nerve fibres using local thresholds. It first partitions the entire image into sub-images and finds the threshold for each sub-image using a histogram-based thresholding method. Then, the pixel-wise threshold is approximated by interpolating the thresholds of neighbouring subimages.

### SUMMARY OF THE INVENTION

It is observed that the existing methods for selecting a threshold described above lack a mechanism for incorporating prior knowledge about the images to be binarised.

Thus, the present invention aims to provide a new and useful technique for selecting a threshold for binarising an image, and in particular one which enables prior knowledge to be explicitly incorporated.

In general terms, the invention proposes firstly that this prior knowledge is used to define a region of interest (ROI) in the image, such that the analysis of frequency distribution of pixel intensities (represented by a frequency histogram) is performed only for pixels in the ROI. Secondly, the invention proposes that the prior knowledge is used to select an intensity range, and that only pixels within this intensity range are used to generate the frequency distribution from which the threshold is selected.

These two ideas are in principle separate, but in combination they provide a highly effective mechanism for incorporating prior knowledge into the threshold selection. The advantage is critical whether the image is a medical one or not. In particular, a threshold can be found to binarise images which exhibits high robustness to imaging artefacts such as gray level inhomogeneity and noise.

Specifically, one expression of the invention is a method of binarising an image composed of pixels having respective intensity values, the method comprising:
(i) using prior knowledge about the image to derive a region of interest within it;
(ii) using prior knowledge about the image to derive an intensity range of pixels in the said region of interest;
(iii) obtaining a frequency distribution of the intensities within the said intensity range of pixels within the said region of interest;
(iv) using the said frequency distribution to derive an intensity threshold; and
(v) binarising the image by classifying pixels in the said region of interest according to whether their intensities are above or below the said intensity threshold.

The invention may alternatively be expressed as a computer system which is set up to perform such a method. Alternatively, it can be expressed as software for performing the method.

### BRIEF DESCRIPTION OF THE FIGURES

Preferred features of the invention will now be described, for the sake of illustration only, with reference to the following figures in which:

FIG. 1 shows the steps in a method which is an embodiment of the invention;

FIG. 2 shows an MR SPGR intercommissural axial slice of a brain, which is a suitable subject for the method of FIG. 1;

FIG. 3 shows a region of interest within the image of FIG. 2 derived by a first step of the method of FIG. 1;

FIG. 4 is a gray-level histogram of the ROI shown in FIG. 3, and a threshold selected in one form of a step of the method of FIG. 1; and

FIG. 5 shows the binarised image using the threshold selected in the method of FIG. 1.

### DETAILED DESCRIPTION OF THE EMBODIMENTS

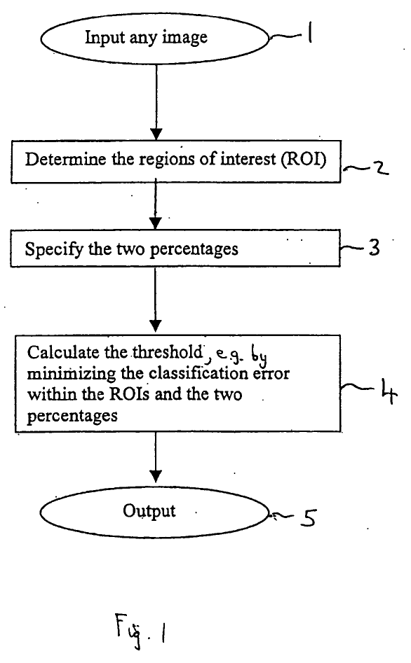

Referring firstly to FIG. 1, the overall steps of a method which is an embodiment of the invention are shown.

In step 1, an image is input.

In step 2, prior knowledge of the image is used to define a region of interest (ROI) which is a subset of the image. This process can be done by whatever means, either automatic, semi-automatic, or even manual.

In step 3 an analysis is performed on the frequency of occurrence of intensities within the ROI, and a range of frequencies is defined, again using prior knowledge.

For example, without losing generality, we denote the image to be processed as f(x), where f(x) is the gray level at a pixel labelled x. It is further supposed that the processed image has L gray levels denoted by rᵢ where i is an integer in the range 0 to L-1 and r₀<r₁< . . . r_{L-1}. It is also assumed that the object of interest has higher intensity values than the background. Suppose that due to prior knowledge or test we know that the proportion of the region of interest which is occupied by the object is in the percentage range per₀ to per₁.

Let h(i) denote the frequency of gray level rᵢ, and let H(i) denote the cumulative frequency which is

$${\sum }_{{i}^{′} = 0}^{i} h ( {i}^{′} ) ,$$

where i′ is an integer dummy index. Considering two values of i written as m and n, the frequency of intensities in the range rₘ to rₙ is

$${\sum }_{{i}^{′} = n}^{n} h ( {i}^{′} ) .$$

Thus, we can use per₀ to calculate a gray level r_{low}, such that we are sure that all the pixels having lower intensity represent background. r_{low} can be written as:

$${r}_{low} = {min}_{i} \{ i \vert H ( i ) \geq {per}_{0} \} . \qquad ( 1 )$$

Similarly, we can use per₁ to calculate a gray level r_{high} such that we are sure that all pixels having higher intensity represent the object:

$${r}_{high} = {min}_{i} \{ i \vert H ( i ) \geq {per}_{1} \} . \qquad ( 2 )$$

In a step 4 of the method of FIG. 1, the threshold is selected using an algorithm which operates on the frequencies within the selected range from r_{low} to r_{high}. The details of several ways in which this can be carried out within the scope of the invention are given below. Thus, a selected threshold is output in step 5.

Image binarisation is then performed using this threshold, to create an image in which all pixels (at least in the ROI) are classified into two classes. Further image processing steps may optionally be performed at this stage.

We now turn to a discussion of three techniques by which step 4 can be carried out.

1. Range-constrained Least Valley Detection Method (RCLVD)

If the frequency range derived in step 3 is correctly estimated then it will include a valley in the frequency distribution of intensities. This valley separates the background and the object. Thus, valley detection can be exploited to select the threshold. This has the following steps:

1) A frequency interval δh is specified.

2) The gray level range [r_{low}, r_{high}] is partitioned into K+1 intervals with an equal frequency range δh. For an interval labelled by integer index j, the lower end of its intensity range is denoted r₁^{j} and the upper end is denoted r₂^{j}. Thus:

$$\begin{matrix}{r}_{1}^{0} = {r}_{low} , {r}_{2}^{0} = {min}_{i} \{ i \vert H ( i ) \geq ( {per}_{0} + δ h ) \} , \\ {r}_{1}^{1} = {r}_{2}^{0} , {r}_{2}^{1} = {min}_{i} \{ i \vert H ( i ) \geq ( H ( {r}_{1}^{1} ) + δ h ) \} , \\ … \\ {r}_{1}^{K} = {r}_{2}^{K - 1} , {r}_{2}^{K} = {min}_{i} \{ i \vert H ( i ) \geq ( H ( {r}_{1}^{K} ) + δ h ) . \\ H ( {r}_{1}^{K} + δ h ) \geq {per}_{1} and H ( {r}_{1}^{K} ) < {per}_{1} .\end{matrix}$$

3) The average frequency h̅^{j} for each of the intervals j is calculated given by h̅^{j}=(H(r₂^{j})−H(r₁^{j))/(r}₂^{j}−r₁^{j})

4) Let J denote the interval for which h̅^{j} is a minimum. The threshold of this RCVLD method, which is denoted θ_{RCVLD}, may be selected to be any value in the range r₁^{j} to r₂^{j}, such as θ_{RCVLD}=(r₂^{j}+r₁^{j})/2.

2. Range-constrained Weighted Variance Method (RCWV)

Let rₖ fall within the range r_{low} to r_{high}, and suppose that the pixels of the ROI are in two classes C₁ and C₂, where C₁ is pixels of the background class and consists of pixels with gray levels r_{low} to rₖ, and C₂ is pixels of the object class and is composed of pixels with gray levels rₖ+1 to r_{high}. The range-constrained weighted variance method maximises the “weighted between-class variance” defined as:

$${θ}_{RCWV} ( {W}_{1} , {W}_{2} ) = {max}_{{r}_{k}} ( Pr ( {C}_{1} ) D ( {C}_{1} ) {W}_{1} + Pr ( {C}_{2} ) D ( {C}_{2} ) {W}_{2} ) ,$$

where W₁ and W₂ are two positive constants selected by the user and representing the weights of the two respective class variances, Pr(.) denotes the class probability, i.e.

$$Pr ( {C}_{1} ) = {\sum }_{i = {r}_{low}}^{{r}_{k}} h ( i ) , \\ Pr ( {C}_{2} ) = {\sum }_{i = {r}_{k} + 1}^{{r}_{high}} h ( i ) ,$$

and D(C₁) and D(C₂) are given by:

$$D ( {C}_{1} ) = {( {μ}_{0} - {μ}_{T} )}^{2} and D ( {C}_{2} ) = {( {μ}_{1} - {μ}_{T} )}^{2} , where {μ}_{T} = {\sum }_{i = {r}_{low}}^{{r}_{high}} i \times h ( i )$$

$${μ}_{0} = {\sum }_{i = {r}_{low}}^{{r}_{k}} i \times h ( i ) and {μ}_{1} = {\sum }_{i = {r}_{k} + 1}^{{r}_{high}} i \times h ( i ) .$$

When W₁ is bigger than W₂, background homogeneity is emphasised.

3. Range-constrained Fuzzy C-partition Thresholding Method (RCFCP)

This third method is related to the technique used in [7], and the justification for it is as given there. In general terms, let A_{b}/A₀ be the fuzzy sets of fuzzy events “background/object” (which denotes a fuzzy partition of the set {r_{low}, . . . , r_{high} with a membership function μ_{A}_{_{b}}/μ_{A}_{₀} respectively). The probability of these fuzzy events are given by:

$$P ( {A}_{i} ) = {\sum }_{j = {r}_{low}}^{{r}_{high}} {μ}_{{A}_{i}} ( j ) \times {h}_{j} ,$$

where Aᵢ∈{A_{b},A₀, and the weighted entropy with this fuzzy partition can be calculated as:
S(W₁,W₂)=W₁×P(A_{b})×log P(A_{b})+W₂×P(A₀)×log P(A₀)
where W₁ and W₂ are two positive constants, and log(.) is the natural logarithm.

Let r_{low}≦a<c≦r_{high}. The membership functions can be defined as follows:

$${μ}_{{A}_{b}} ( x ) = \{ \begin{matrix}1 , & {r}_{low} \leq x \leq a \\ ( x - c ) / ( a - c ) & a < x < c \\ 0 & c < x \leq {r}_{high}\end{matrix} \\ and \\ {μ}_{{A}_{0}} ( x ) = \{ \begin{matrix}1 , & {r}_{low} \leq x \leq a \\ ( x - a ) / ( c - a ) & a < x < c \\ 0 & c < x \leq {r}_{high}\end{matrix} .$$

The optimum parameters a* and c* are chosen to maximise the entropy S(W₁, W₂), and the optimum threshold is θ_{RCFCP}=(a*+c*)/2.

Having now presented the steps of the embodiment in principle, we turn to an example of the embodiment in operation. This example uses the form of step 4 referred to above as RCLVD.

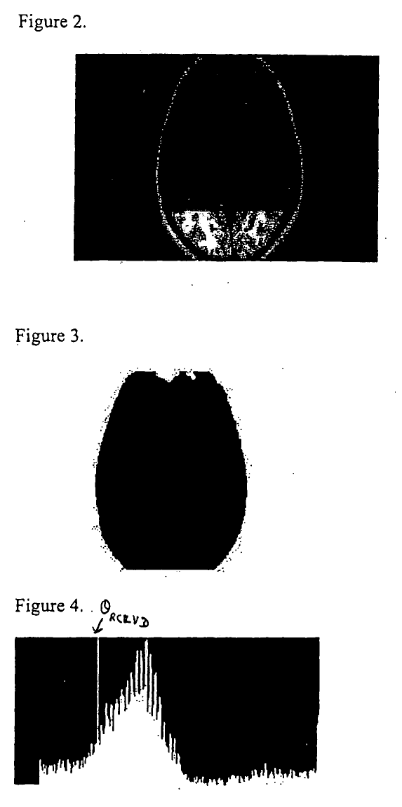

The starting point of the method is the image shown in FIG. 2, an MR (Magnetic Resonance) image which is a T1-weighted or SPGR (spoiled gradient recalled acquisition) axial slice around the intercommissural plane. This image is input in step 1 of the method.

In step 2 of the method, we calculate the pixels enclosed by the skull (i.e. find the ROI) using the following steps: the usual histogram-based thresholding method is used to binarise the axial slice; a morphological closing operation is used to connect small gaps; the largest connected component is identified; and the holes within the component are filled. The resulting ROI (the pixels enclosed by the skull) is shown in FIG. 3.

In step 3, the two percentages pero and per, are set as 14% and 28%. This selection is based on previous experiments and/or other prior knowledge.

In step 4 of the method (RCLVD), we select the δh to be 1% (alternatively any value in the range 1% to 5% would be suitable). FIG. 4 shows the histogram of frequencies in the ROI, and the calculated threshold θ_{RCLvD} is shown as the line indicated. This completes the procedure of the embodiment.

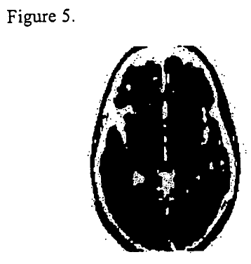

The output threshold of the method is used as in conventional techniques to binarise the image. The binarised image is shown in FIG. 5.

Although only a single embodiment of the invention has been described, many variations are possible within the scope of the invention as will be clear to a skilled reader.

### REFERENCES

The disclosure of the following references is incorporated herein by reference in their entirety:
[1] Otsu N., “A threshold selection method from gray-level histograms”, IEEE Transactions on Systems, Man and Cybernetics, 1979; 9: p62-66.
[2] Li C. H., Lee C. K., “Minimum cross entropy thresholding”, Pattern Recognition 1993; 26: p617-625.
[3] Kittler J., Illingworth J., “Minimum error thresholding”, Pattern Recognition 1986; 19: p41-47.
[4] Kapur J. N., Sahoo P. K., Wong A. K. C., “A new method for gray-level picture thresholding using the entropy of the histogram”, Computer Vision Graphics and Image Processing, 1985, 29; 273-285.
[5] Wong A. K. C. and Sahoo P. K., “A gray-levl threshold selection method based on maximum entropy principle”, IEEE Transactions on Systems, Manand Cybernetics, 1989; 19: p866-871.
[6] Saha P. K. and Udupa J. K., “Optimum image thresholding via class uncertainty and region homogeneity”, IEEE Transactions on Pattern Analysis and Machine Intelligence, 2001; 23: p689-706.
[7] Cheng H. D., Chen J., and Li J., “Threshold selection based on fuzzy c-partition entropy approach”, Pattern Recognition 1998; 31: p857-870.

1. A method of binarising an image composed of pixels having respective intensity values, the method comprising:
(i) using prior knowledge about the image to derive a region of interest within it;
(ii) using prior knowledge about the image to derive an intensity range of pixels in the said region of interest;
(iii) obtaining a frequency distribution of the intensities within the said intensity range of pixels within the said region of interest;
(iv) using the said frequency distribution to derive an intensity threshold; and
(v) binarising the image by classifying pixels in the said region of interest according to whether their intensities are above or below the said intensity threshold.

2. A method according to claim 1 in which in step (iv), the threshold is found by deriving a valley in the frequency distribution within the range, and selecting the intensity threshold to correspond to the valley.

3. A method according to claim 2 in which the valley is found by determining the total intensities in a number of intervals defined in the range, and selecting the intensity threshold as an intensity within the interval having the lowest total intensity.

4. A method according to claim 3 in which the intensity threshold is selected as the mid-point of the interval having the lowest total intensity.

5. A method according to claim 1 in step (iv) the threshold is found by minimising a function which is a sum of the variances of the intensities below and above the threshold.

6. A method according to claim 5 in which the sum is a weighted sum defined based on two constants W₁ and W₂.

7. A method according to claim 6 in which, representing labelling the possible values of pixel intensity by an integer index i and their respective frequencies by h(i), and writing the lower and upper intensities respectively as r_{low} and r_{high} the weighted sum is given by
$${θ}_{RCWV} ( {W}_{1} , {W}_{2} ) = {max}_{{r}_{k}} ( Pr ( {C}_{1} ) D ( {C}_{1} ) {W}_{1} + Pr ( {C}_{2} ) D ( {C}_{2} ) {W}_{2} ) ,$$
where Pr(.) denotes the class probability
$$( Pr ( {C}_{1} ) = {\sum }_{i = {r}_{low}}^{{r}_{k}} h ( i ) and Pr ( {C}_{2} ) = {\sum }_{i = {r}_{k} + 1}^{{r}_{high}} h ( i ) ) ,$$
and D(C₁) and D(C₂) are given by:
$$D ( {C}_{1} ) = {( {μ}_{0} - {μ}_{T} )}^{2} and D ( {C}_{2} ) = {( {μ}_{1} - {μ}_{T} )}^{2} , where {μ}_{T} = {\sum }_{i = {r}_{low}}^{{r}_{high}} i \times h ( i ) , \\ {μ}_{0} = {\sum }_{i = {r}_{low}}^{{r}_{k}} i \times h ( i ) and {μ}_{1} = {\sum }_{i = {r}_{k} + 1}^{{r}_{high}} i \times h ( i )$$

8. A method according to claim 1 in which step (iv) is performed by selecting the threshold as a function of parameters which maximise an entropy function which indicates the entropy of a fuzzy partition of the pixels into classes based on the parameters.

9. A method of processing an image which includes binarising it by a thresholding method according to claim 1, and then modifying the classification of one or more of the pixels by considering spatial relationships between the locations of the classified pixels.

10. A computer program product comprising a recording medium and programming instructions stored on the recording medium and readable by a computer system to cause the computer system to perform a method according to claim 1.

11. A computer system for binarising an image composed of pixels having respective intensity values, the system including:
(i) at least one data input device for a user to select a region of interest in the image and specify a frequency range within the frequency distribution of the intensities of pixels in the region of interest;
(ii) a processor arranged to obtain a frequency distribution of the intensities within the intensity range of pixels within the region of interest, use the frequency distribution to derive an intensity threshold; and binarise the image by classifying pixels in the region of interest according to whether their intensities are above or below the threshold.

12. A system according to claim 11 in which the processor is arranged to derive the threshold by deriving a valley in the frequency distribution within the range, and selecting the intensity threshold to correspond to the valley.

13. A system according to claim 12 in which processor is arranged to find the valley by determining the total intensities in a number of intervals defined in the range, and selecting the intensity threshold as an intensity within the interval having the lowest total intensity.

14. A system according to claim 13 in which the processor is arranged to select the intensity threshold as the mid-point of the interval having the lowest total intensity.

15. A system according to claim 14 in which the processor is arranged to select the threshold by minimising a function which is a sum of the variances of the intensities below and above the threshold.

16. A system according to claim 15 in which the sum is a weighted sum defined based on two constants W₁ and W₂.

17. A system according to claim 16 in which, representing labelling the possible values of pixel intensity by an integer index i and their respective frequencies by h(i), and writing the lower and upper intensities respectively as r_{low} and r_{high}, the weighted sum is given by
$${θ}_{RCLWV} ( {W}_{1} , {W}_{2} ) = {max}_{{r}_{k}} ( Pr ( {C}_{1} ) D ( {C}_{1} ) {W}_{1} + Pr ( {C}_{2} ) D ( {C}_{2} ) {W}_{2} ) ,$$
where Pr(.) denotes the class probability
$$( Pr ( {C}_{1} ) = {\sum }_{i = {r}_{low}}^{{r}_{k}} h ( i ) and P r ( {C}_{2} ) = {\sum }_{i = {r}_{k} + 1}^{{r}_{high}} h ( i ) ) , ,$$
and D(C₁) and D(C₂) are given by:
$$D ( {C}_{1} ) = {( {μ}_{0} - {μ}_{T} )}^{2} and D ( {C}_{2} ) = {( {μ}_{1} - {μ}_{T} )}^{2} , where {μ}_{T} = {\sum }_{i = {r}_{low}}^{{r}_{high}} i \times h ( i ) , \\ {μ}_{0} = {\sum }_{i = {r}_{low}}^{{r}_{k}} i \times h ( i ) and {μ}_{1} = {\sum }_{i = {r}_{k} + 1}^{{r}_{high}} i \times h ( i ) .$$

18. A system according to claim 11 in which the processor is arranged to select the threshold as a function of one or more parameters which maximnise an entropy function which indicates the entropy of a fuzzy partition of the pixels into classes based on the parameters.

19. A system according to claim 11 in which the processor is further arranged to process the segmented image by modifying the classes to which each pixel is allocated by considering relationships between the locations of the pixels which have been classified.
